(19) United States
(12) Patent Application Publication
(10) Pub. No.: US 2003/0069854 A1
(43) Pub. Date: Apr. 10, 2003

(54) Expiring content on playback devices

(76) Inventors: Michael M. Hsu, San Jose, CA (US); Dennis J. McMahon, Tracy, CA (US); Donald J. Spencer, San Jose, CA (US)

Correspondence Address: FISH & RICHARDSON P.C., 500 ARGUELLO STREET, SUITE 500, REDWOOD CITY, CA, 94063, US

(21) Appl. No.: 09/974,946

(22) Filed: Oct. 9, 2001

(51) Int. Cl. G06F 17/60

(52) U.S. Cl. 705/59

(57) ABSTRACT

Methods, apparatus and system, including computer program products, implementing and using techniques for transferring one or more media files from a content server to a media playback device. A request of one or more media files to be transferred to a particular media playback device is received. The one or more media files have associated expiration rules. Information about the particular media playback device is obtained. Based on the information, it is determined whether the particular media playback device has the capability to enforce the expiration rules associated with the one or more media files. If so, the media files are formatted such that they can only be rendered by the particular playback device and transferred to the device with the expiration rules. A method and apparatus for playing media files and a method and apparatus for updating expiration data are also described.

### BACKGROUND

This invention relates to downloading of media files through a communications network.

Music and other types of audio recordings are conventionally sold to consumers through stores or mail-order companies. When music or audio recordings are sold through these types of outlets, the recordings are usually distributed on tangible media, such as compact discs, magnetic cassette tapes, digital tapes, and so on. Another, alternative way of distributing music is to receive orders and to distribute music electronically over a communications network, such as the Internet. A person can connect to a music provider and download music over the Internet, either for free or for a fee. A few examples of providers that make digital audio files available of downloading are RealNetworks Inc., Audible Inc., MP3.com Inc. and Emusic.com Inc.

The downloaded music can be played back with appropriate audio playback software on the user's computer, either while the computer is connected to the Internet (that is, through streaming playback of the audio files), or at later time. Examples of common software for playing audio files include the RealPlayer and the Windows MediaPlayer software. The user may organize his or her downloaded audio files into a personal jukebox on his or her computer. The user may also optionally transfer the downloaded audio files from his or her computer to a portable player that can play back audio files, so that he or she can leave his or her computer and still be able to listen to the previously downloaded audio files.

When one buys music stored on a tangible medium, such as a CD or a cassette tape, the purchaser gets unlimited rights to playback the music for his or her personal use. Music that is provided through digital delivery to a playback device can have an associated expiration, such as time-limited playback rights, or rights that allow a user to play the audio files only a certain number of times. A user may therefore select music for a playback device and listen to the selected music during a certain time period or a certain number times for smaller fee, or even for free, compared to what he or she would have paid if the music were stored on a tangible medium. If the user after this time likes the music, he or she can choose to refresh the expiration of the music and obtain new playback rights.

A problem with time-limited playback is that users may change internal clocks on playback devices that are used to keep track of the expiration dates or the number of remaining playbacks. As a consequence, the time limitation or the playback limitation imposed by the music provider will not work, and the music providers will have little interest in providing audio files for a reduced fee compared to the fee for unlimited playback. It is therefore likely that content providers would offer a more limited service or charge higher prices than what would be necessary if there were a way to guarantee that users could not manipulate the imposed expiration limitations on the audio files, leaving potential customers with less than a full range of options to choose from.

### SUMMARY

In general, in one aspect, this invention provides methods, apparatus, and systems, including computer program products, implementing and using techniques for transferring one or more media files from a content server to a media playback device. A request of one or more media files to be transferred to a particular media playback device is received. The one or more media files have associated expiration rules. Information about the particular media playback device is obtained. Based on the information about the particular media playback device, it is determined whether the particular media playback device has the capability to enforce the expiration rules associated with the one or more media files. If the media playback device has the capability to enforce the expiration rules, the requested one or more media files are formatted such that they can only be rendered by the particular playback device and the formatted files and the expiration rules are transferred to the particular media playback device.

Advantageous implementations can include one or more of the following features. The media files can have associated content rights and it an be determined, based on the information about the particular media playback device, whether the particular media playback device satisfies the content rights associated with the one or more media files. If the particular media playback device does not satisfy the content rights, transfer of the one or more media files to the particular playback device is denied. The media files can have associated content rights and information can be obtained about a user account associated with the particular media playback device. The user account can have associated usage rights. It can be determined, based on the information about the user account, whether the usage rights satisfy the content rights associated with the one or more media files and if the usage rights do not satisfy the content rights, the transfer of the one or more media files to the particular playback device can be denied.

The information about the particular media playback device can include a unique device identifier and device capabilities for playing media files. A current time stamp can be generated and the current time stamp can be transferred to a secure location on the media playback device. The expiration rules can include a maximum number of playbacks for the one or more media files, a relative expiration time for the one or more media files or an absolute expiration time for the one or more media files.

In general, in one aspect, this invention provides methods, apparatus, and systems, including computer program products, implementing and using techniques for updating expiration rules for media files to be played on a media playback device. A request for updating expiration rules for one or more media files is received. Information about a particular media playback device is obtained. Current expiration rules for the one or more media files for which an update has been requested are obtained. The current expiration rules are compared with expiration rules stored on the content server for the one or more media files to determine if the current expiration rules can be updated. If the current expiration rules can be updated, new expiration rules are transferred from a content server to the particular media playback device. If the current expiration rules cannot be updated, a user of the particular media playback device is requested to perform an action before the current expiration rules can be updated. If the user performs the requested action, new expiration rules are transferred from the content server to the particular media playback device.

Advantageous implementations can include one or more of the following features. Transferring new expiration rules from the content server can include transferring the new expiration to a communication module that is operable to communicate with the playback device and transferring the new expiration rules from the communication module to the playback device.

In general, in one aspect, this invention provides methods, apparatus, and systems, including computer program products, implementing and using techniques for playing a media file on a playback device. A user request to play the media file is received. The media file has one or more associated expiration rules. The one or more expiration rules associated with the requested media file are read. It is determined, based on the one or more expiration rules, if the media file has expired. If the media file has expired, playback of the media file is refused until one or more new expiration rules have been obtained. If the media file has not expired, the media file is played to the user.

Advantageous implementations can include the following feature. A storage medium on the particular playback device can be validated.

The invention can be implemented to realize one or more of the following advantages. Audio files provided with expiration information can be delivered to users' playback devices and their expiration can be securely controlled. Users may rent audio files for certain time period, download them as a promotional offer or try them out for a specific time period. Content providers can impose different limitations, depending on what type of playback device the user has or what type of operation he or she wishes to perform on the files. For example, one fee can be charged for a one-time playback of the audio file, while another fee can be charged for unlimited playback, and yet another fee can be charged for a certain number of playbacks. Similarly, one fee can be charged for a 24 hour rental of the music, while another fee can be charged for a month long rental of the music, and so on. Content providers can provide more extensive services, such as subscription programs or promotional programs, for music that has a high value.

The details of one or more implementations of the invention are set forth in the accompanying drawings and the description below. Other features and advantages of the invention will be apparent from the description and drawings, and from the claims.

### DETAILED DESCRIPTION OF THE DRAWINGS

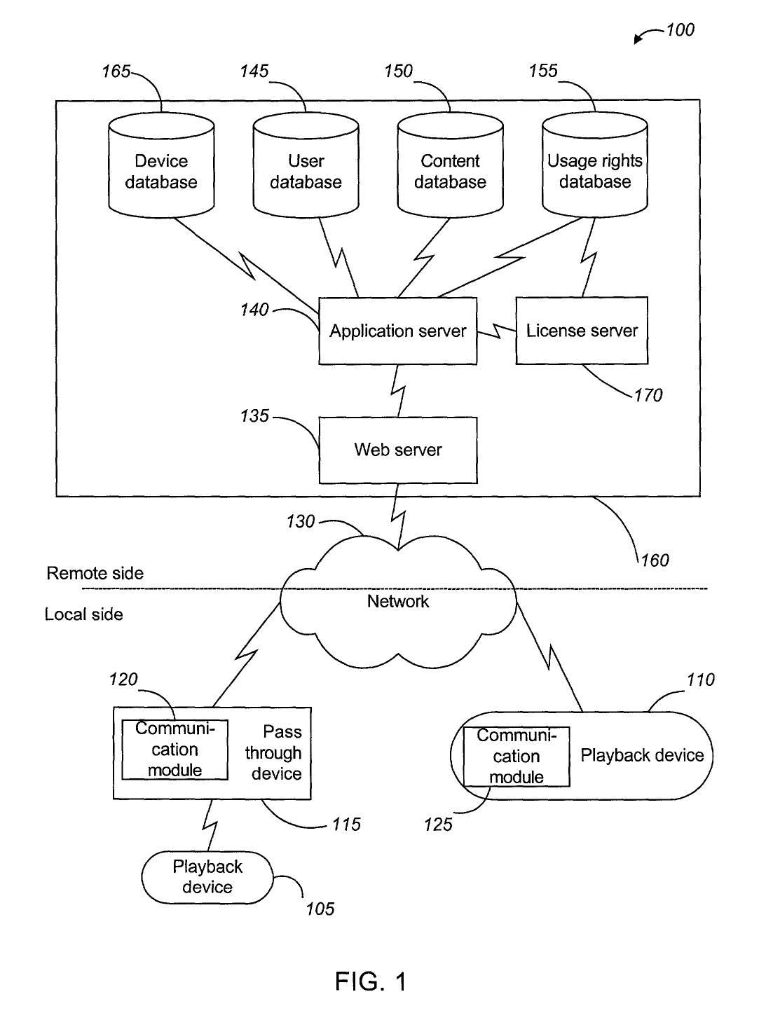

FIG. 1 is a schematic diagram showing a delivery system for audio files having an associated expiration condition.

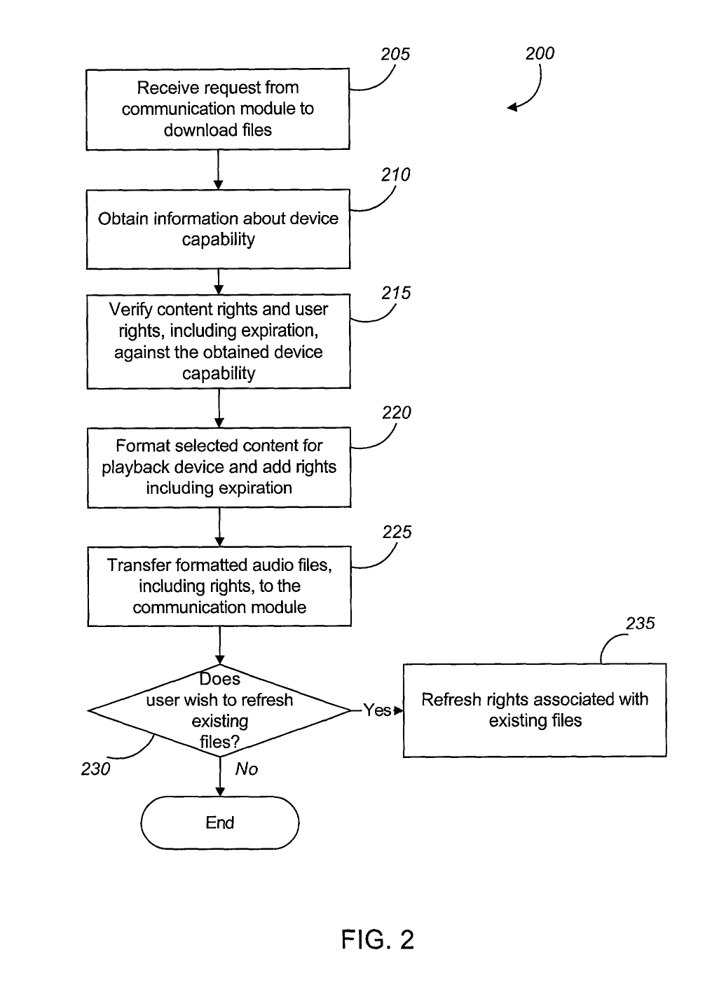

FIG. 2 is a flowchart showing a process for downloading audio files having an associated expiration condition to a playback device.

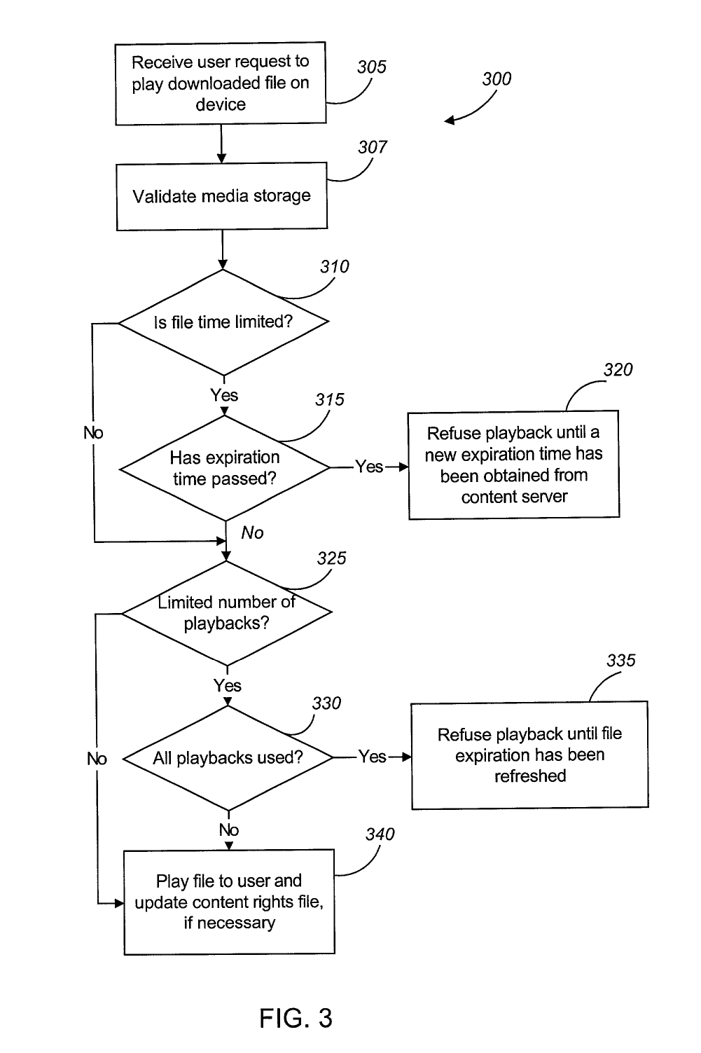

FIG. 3 is a flowchart showing a process for playing audio files with an associated expiration condition.

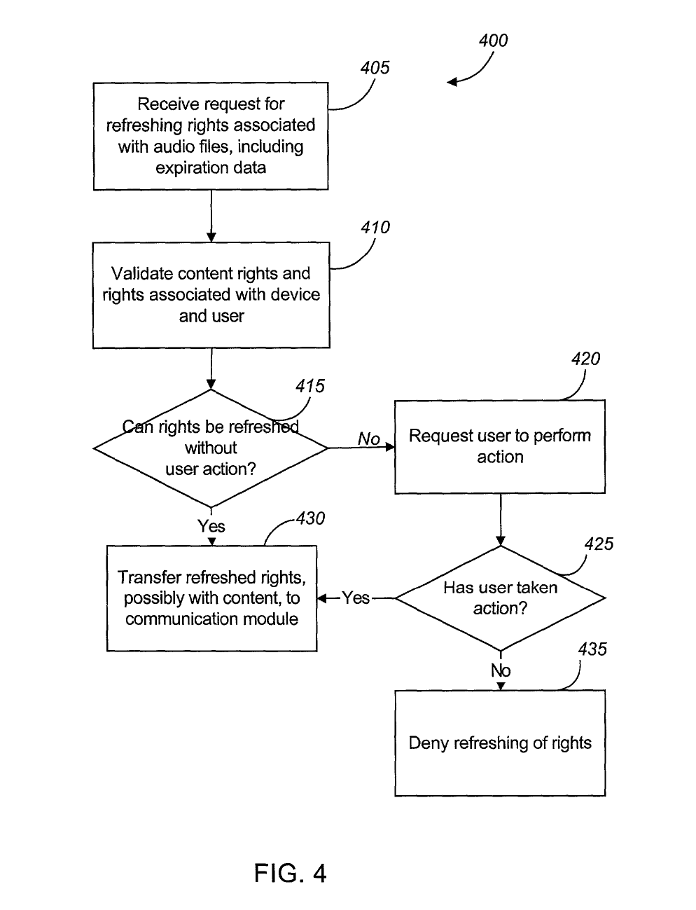

FIG. 4 is a flowchart showing a process for refreshing an expiration condition for audio files that is stored on a playback device.

Like reference symbols in the various drawings indicate like elements.

### DETAILED DESCRIPTION

The invention will be described below by way of example of audio files and a digital audio playback device. A schematic view of a system for delivering audio files with an expiration condition to a playback device in accordance with invention is shown in FIG. 1. A similar system, in which the invention also can be applied, is described in commonly-owned U.S. patent application Ser. No. 09/894,846, filed Jun. 27, 2001, which is hereby incorporated by reference in its entirety. As shown in FIG. 1, a system (100) for delivery of audio files to a particular device has a local side and a remote side. The concepts local side and remote side of the system are used here from a system user's (that is, consumer's) point of view.

In one implementation of the system, the remote side includes a content server (160) that interacts with the users' playback devices during a delivery of audio files to the users' audio playback devices. The content server (160) includes a web server (135), an application server (140), a user database (145), a content database (150), a device database (165), and a license server (170) with an associated user rights database (155). The different components of the content server can be integrated into one or several physical units, depending on the needs of the service provider, and the units can be connected with conventional communication links. The devices at the local side of the system include devices that belong to users, such as a digital audio playback device (105,110) and optionally a pass-through device (115), such as a computer or set-top box, to which the user can connect an audio playback device. Optionally the pass-through devices can have the functionality for playing audio files as well. A computer can, for example, function both as a pass-through device and a playback device. It should also be noted that pass-through devices are not limited to set-top boxes and computers. Virtually any device that can connect to a content server over a network such as the Internet and that is provided with a port (for example, a USB port) to which a playback device can be connected can be used as a pass-through device.

Many other system configurations are possible, as will be clear from the following description. Furthermore, throughout the specification reference will be made to audio files or to digital audio files. Audio in this context refers to any audible content, tone, or sound, regardless of how the audio has been generated. Audio can include, for example, music, songs, tunes, tracks, titles, voice, speech and other content similar or analogous to content that can be provided by a broadcast radio station.

At the remote side of the system, the web server (135) is the part of the content server (160) that is used to provide a user interface between the users that are connected to a communication network (130) and the application server (140), which is the central part of the content server (160). The web server typically hosts web pages that are associated with a user interface and services for selecting audio files to transfer from the server to a pass-through device (115) or playback device (105, 110) and web pages that are associated with the management of the personal user account. A user can view the web pages either in a web browser on his or her computer, or on a display on a playback device, such as home stereo or a personal digital assistant (PDA), for example. The user can either purchase the audio files for unlimited playback on his or her playback device (105, 110), or rent the audio files for a time limited period or a limited number of playbacks, or receive them for free as a promotional offer.

The web server (135) communicates with the application server (140). The application server does not allow any direct user interaction. Any commands the user wishes to send the application server have to go through a communication module (120, 125) on the local side of the system and/or a web browser that is in communication with the web server (135) on the remote side of the system. The communication module (120, 125) will be described in further detail below. The application server acts as a coordinator for the content server (160) and can communicate with the communication modules (120,125) on the local side of the system, the web server (135), the user database (145), the content database (150), the device database (165) and the license server (170) with its associated usage rights database (155) on the remote side of the system. The restriction that are user has to communicate with the application server through a web browser and a web server makes it possible to abstract user interfaces and serving web pages from the back and functions of the application server. However, in a different implementation, the communication layer on the application server can provide the functionality for communicating with the devices on the local side in different ways, such as directly with communication module that can handle communication relating to file delivery and device status, without providing any user interface.

The user database (145) contains information about the users and information relating to their digital media playback devices (105, 110), in particular what devices are associated with what users. The content database (150) is a database in which audio files and associated metadata are stored. The device database (165) contains information about different types of audio playback devices (105, 110) and their capabilities of playing back different types of audio files. The usage rights database (155) contains usage rights for the audio files in the content database. The license server (170) receives requests for licenses from the application server (140) and issues licenses in response to the requests, based on information in its associated usage rights database (155).

On the local side of the delivery system, a communication module (120, 125) is designed to communicate with the application server (140). The communication module (120, 125) can be located in a playback device (105, 110), or in a pass-through device (115). The communication module (120, 125) contains the functionality required for communicating with the content server (160), including sending requests and information about the playback device to the content server (160) and receiving audio files and instructions from the content server (160). The communication module can be implemented in software or firmware, so that it can be implemented both on devices without full operating systems and devices with full operating systems. Examples of requests that a communication module can send to the server include requests to get new audio files, requests update the expiration information for audio files, requests to log on, and requests to authenticate the playback device. In addition to requests, a communication module can also send status information for the playback device to the content server. Examples of instructions that can be received from the content server include instructions for updating existing expiration information or adding new expiration information for certain audio files, deleting audio files, permission to log on, and so on. The communication module forwards the received instructions, including translating them into a different format if needed, to a content rights management (CRM) library residing on the device, which contains content rights management functions that are used to manage the audio file rights on the playback device. This will be described in further detail below.

One example of a communication module (120, 125) with extended functionality is a download manager that has added support for content rights management (CRM). The download manager's properties and methods are fully described in U.S. patent application Ser. No. 09/894,846. The download manager contains a web browser interface, inside which a browser specific core and a common core reside. The common core offers a common set of services (that is, properties and methods) that can be used by the browser specific components. The common core also forms an interface to a media device manager (MDM) and a digital rights manager (DRM).

The CRM library is a supplement to the DRM functionality in that it provides additional content management capabilities, in particular relating to play counts and time-based expirations (relative as well as absolute). CRM functions on the device include functions for validating the storage medium on which the audio files are stored, functions for checking if playback rights of audio files stored on the playback device have expired, functions for accessing device specific features and functions for reading data from and writing data to secure storage areas on the playback device. Other CRM functions that can be located either on the playback device or on the content server include functions for setting a play count, functions for setting an absolute expiration time, functions for setting a relative expiration time, functions for expiring content based on a clock at the content server and functions for deleting audio files or expiration information from the playback device.

A small secure permanent storage area (measured in kilobytes) is required in the playback device for managing each storage medium (internal or external) that can be attached to a playback device (105, 110). The information for each storage medium in the secure storage area includes an identifier (ID) of the medium and a hash value for a content rights file containing the rights for the audio files on the storage medium. Typically, a readable and writeable area of an internal flash memory in the playback device is used for the secure permanent storage area. The secure storage area does not have to exist within an audio file system on the device or be accessible by the device command set, but it must be accessible by the device software or firmware on the device that is responsible for decrypting and rendering the content.

The rights information associated with audio files is generally stored as individual records in a content rights file on the file system of the target storage medium in the playback device (105, 110). The records in the content rights file include information such as how many times an audio file has been played or can be played, whether there is any absolute or relative expiration time associated with the audio file, and so on. Most conventional playback devices store the audio files in a file system that has a publicly documented command set. The CRM must therefore employ cryptographic means to ensure that the rights data associated with the audio files is not tampered with. Forms of tampering include file creation, deletion and renaming, and file content modification. To resist tampering, the file name of the content rights file is computed by hashing the device ID and the storage medium ID. The resulting hashed file name is stored in the secure storage area of the playback device (105, 110), where it can only be accessed by the device firmware and not by any users.

A process for transferring audio files with associated expiration information from the content server (160) to a particular playback device (105, 110) will now be described. It is assumed that a communication module for a playback device is connected to the communication network and that a user and the communication module for the playback device have been identified to the content server. The user who issues the request for having the files transferred to his or her playback device can also have registered himself or herself and the playback device, or has connected the playback device to the network, so that the corresponding user information and device information exist in the user database and device database, respectively.

As shown in FIG. 2, a process (200) for transferring audio files with expiration information starts with receiving a request from a communication module (120, 125) associated with a particular playback device (105, 110) of audio files to be transferred from the content server (160) to the communication module (120, 125) that is associated with the particular playback device (105, 110) (step 205). The request has been generated in response to a user initiated event, such as a user having selected files to be transferred from a conventional online store to his or her playback device for purchase, for rental, or for promotional purposes. Alternatively, the request can have originated at the content server (160), for example, if the user has selected a monthly subscription for a certain type of audio files and the server has determined that it is time to deliver the next month's audio files to the user's playback device.

After the request has been received, the content server (160) obtains information about the device capability (step 210). This information can be obtained from a database in which the information has been previously stored, or from the communication module (120, 125) associated with the particular device (105, 110). The device capability information includes both physical information, such as what types of files the playback device (105, 110) can play, the available space on the playback device (105, 110), serial number, manufacturer, model, and so on, and information about what rights are associated with the playback device (105, 110) or with the user account associated with the playback device. Two users can, for example, have the same type of playback device (105, 110) but have different rights associated with their accounts, so that the first user can play files and transfer them to other playback devices (105, 110), while the second user only can play the files on the particular playback device (105, 110).

The content server (160) verifies the rights associated with the selected audio files, including the expiration rules for the audio files, against the obtained device capability (step 215). The rights associated with audio files are imposed by the audio file provider, and can include, for example, unlimited playback during a certain time period, free playback a certain number of times, playback a certain number of times within a given time period, and so on. The content server (160) then formats the selected audio files for the playback device (105, 110) and adds the rights including the expiration information to the audio files (step 220).

Alternatively, the content server can generate a license that controls what operations a user can perform on the audio files after they have been transferred to his or her playback device. The license can further include the expiration limitations, and is sent separately to the communication module. The license information with the content expiration information is stored separately at the user's playback device rather than being added to the audio files by the server at the remote side.

The audio files can additionally have other associated rights that control to what devices they may be transferred. For example, a file “Symphony No. 5” can have associated rights saying that it may only be transferred to devices that can time out content using dates and not play counts and that do not have more than 128 MB of total memory. There can also be associated rights that relate to a user account rather than to device capabilities. For example a file “Symphony No. 2” can have associated rights saying that it can only be transferred to a device that is registered with a user account for which a premium subscription service has been selected. If the audio files have rights of this type associated, then the process checks these rights as well during the verification step.

The formatting of audio files for a particular playback device is described in U.S. patent application Ser. No. 09/894,846. The audio files are formatted so that they can only be played on the particular device or on a particular type of device. This can be done, for example, by using the serial number of the device when formatting the audio files. In an alternative implementation, the device can use a different ID such as a randomly generated 128 bit number implanted at the time a manufacturing, as the unique ID. A smaller, non-random serial number can be used for other purposes, such as customer service and repair and sales information tracking. In the case of a personal computer using a Windows Media Digital Rights Manager (WMDRM), the unique number can be obtained by prompting the WMDRM to generate a number. The WMDRM then generates a so called challenge number that is unique to that computer different every time it is generated. This number can be used as a unique identifier.

After the content server (160) has formatted the audio files, the audio files are transferred to the communication module (120, 125) for the particular playback device (105, 110) (step 225). The communication module (120, 125) stores the audio files either on the playback device (105, 110) or at an intermediary storage location, from which they are later transferred to the playback device (105, 110). The communication module can additionally perform content rights management functions on the audio files if the server sends content rights management commands.

After the files have been transferred to the playback device (105, 110), the process checks whether the user wishes to refresh the expiration information for any existing audio files on the playback device (105, 110) (step 230). If the user wishes to refresh rights associated with existing audio files, for example, if one or more of the files have expired, the process continues with refreshing the associated rights for the audio files (step 235), which will be further explained with reference to FIG. 4. If the user does not wish to refresh the rights, the process ends.

FIG. 3 shows a process (300) for playing a file that has been downloaded from the content server (160) to a playback device (105, 110). The process starts with receiving a user request to play an audio file on the playback device (105, 110) (step 305). In response to the request, the software on the playback device (105, 110) calls a storage medium validation function (step 307) for the storage medium where the audio file is located. The validation function is part of the CRM library and attempts to verify the integrity of the content rights file stored on the target storage file system by calculating the secure hash value of the content rights file for the selected medium and comparing this calculated hash value with the stored value in the playback device's protected storage area. If the media validation function fails, the device will not play any files that are stored on the storage medium.

If the validation is successful, the process checks the record in the content rights file associated with the requested audio file to see if the audio file is time-limited (step 310). The time limitation associated with a file can either be an absolute time limitation such as “This file will no longer be valid after Oct. 1, 2002,” or relative time limitation such as “This file will be valid for 24 hours from the time it is first played on this the playback device.” If there is a time limitation associated with the file, the process continues by checking whether the expiration time (relative or absolute) has passed (step 315). If the expiration time has passed, the process refuses to play the file until a new expiration time has been obtained from the content server (160) (step 320).

If the process determines that the expiration time has not passed (step 315), or if the file is not time-limited (step 310), the process continues by checking the content rights file to see if the file is limited to a certain number of playbacks (step 325). If the file is limited to a certain number of playbacks, the process checks if all playbacks have been used (step 330). If all the playbacks have been used, the process refuses to play the file until the file expiration information, that is, the maximum number of playbacks, has been refreshed (step 335). If there are still playbacks left (step 330), or if the file does not have any associated maximum number of playbacks (step 325), the process proceeds to play the audio files to the user and update the content rights file if necessary, for example, if a remaining playback count is decremented (step 340). When the content rights file is updated, the hash is recalculated and the hash value stored in the secure storage area is updated.

In one implementation, every time the user connects to the content server (160), using the communication module (120, 125) for a particular playback device (105, 110), the server generates the time stamp that is transferred to the communication module (120, 125) and subsequently to the playback device (105, 110). If an audio file is time-limited and the playback device (105, 110) does not have a secure clock, that is, the clock in the playback device (105, 110) can be manipulated by a user, the playback process uses the time stamp as a reference time when checking if the expiration time has passed (see step 315, in FIG. 2). The time stamp is also used as a reference if the playback device (105, 110) has no internal clock at all. This time stamp will not be as exact as a secure clock, but will work well since it is updated every time the user connects to the content server (160) and a user can be encouraged to connect to the server by additionally limiting the playback rights by allowing only a limited number of playbacks at a time.

FIG. 4 shows a process (400) for refreshing expiration information associated with one or more audio files residing on a user's playback device (105, 110). The process starts by receiving a request for refreshing expiration information associated with audio files (step 405). This request can be received from the user, for example through a web page hosted by a service provider on which the user can manage audio files associated with his or her playback device (105, 110) or account. Alternatively, the request can be generated automatically as part of the download process, such as the one shown in FIG. 2, or when a user tries to play back files using a jukebox application performing a process such as the one shown in FIG. 3. The process validates the content rights and rights associated with the device and the associated user account (step 410), in the same manner that was described above for step 215 (FIG. 2).

If the content rights, that is, the rights associated with a device and the user rights associated with the user account are validated, that is, if the user is allowed to transfer the audio files to his or her playback device (105, 110), the process continues by deciding whether the rights can be refreshed without any additional user action (step 415). The additional user action can, for example, involve paying more money in order to extend the expiration condition (play count or time period) or downloading a promotional file before extending the expiration for the desired audio file, and so on. If a user action is needed, the process prompts the user to perform the user action (step 420). The process then checks if the user has taken a necessary action (step 425). If the user has taken the action, or if the audio files can be refreshed without a user action (step 415), the process continues and transmits the refreshed rights to the communication module (120, 125) associated with a playback device (105, 110) (step 430). If the audio files still reside on the device but have expired, only the updated expiration information is sent to the communication module (120, 125). If the audio files have been deleted from the playback device (105, 110), the process also transfers the refreshed to audio files with their rights to communication module (120, 125) for the particular playback device (105, 110).

In one implementation, the content rights file on the playback device (105, 110) is updated by a content rights management module running on the content server (160) by appending a secure signed command block to the content rights file. The validation function, which was discussed above, verifies the command block signature and executes the command on behalf of the content server (160). As was described above, typical refreshing commands include reset CRM, set play count, set absolute expiration time, set relative expiration time, send a time stamp to the playback device (105, 110), and delete a record (that is, an audio file entry) from the content rights file. If the user does not take a necessary action in step 425, the process denies refreshing the rights associated with the audio file (step 435).

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

A number of implementations of the invention have been described. Nevertheless, it will be understood that various modifications can be made without departing from the spirit and scope of the invention.

For example, in the above specification playbacks related to a maximum playback count or to a time limitation (relative or absolute) were described. However, playback limitations can depend on other factors as well, such as the presence or absence of other audio files. For example, a user can have to download two extra promotional audio files in order to get the audio file that he or she really wants.

The CRM functions can be distributed in various ways between the communication module and the content server. An intelligent communication module can be implemented to handle commands that are more complex, and to be more similar to a download manager in that it does not require much support from the server, while a non-intelligent communication module can be implemented to contain only the basic functions and to require that more tasks be performed by the server.

A web server is not the only type of user interface that can be used by a system in which the invention can be implemented. Any means of communication with a remote device would work, and any means of communication will work as well. The invention is not dependent on the type of connection with the device or user as long as data can be transferred from one place to another.

For closed system devices without complete operating systems, an area of non-volatile memory that can only be read or written to by the device firmware can be a secure storage area. On open devices with more functional operating systems, such as personal computers, an alternate method of establishing a secure area must be used. An example of such an alternate method is the creation of an encrypted file that can only be read by a tamper resistant software application or module.

The invention has been described above for audio files in particular, but is also applicable to other types of media files, such as video files, and corresponding media playback devices for playing back files of this type.

Accordingly, other embodiments are within the scope of the following claims.

What is claimed is:

1. A method for transferring one or more media files from a content server to a media playback device, comprising:
receiving a request of one or more media files to be transferred to a particular media playback device, the one or more media files having associated expiration rules;
obtaining information about the particular media playback device;
determining, based on the information about the particular media playback device, whether the particular media playback device has the capability to enforce the expiration rules associated with the one or more media files;
if the media playback device has the capability to enforce the expiration rules, formatting the requested one or more media files such that they can only be rendered by the particular playback device and transferring the formatted files and the expiration rules to the particular media playback device.

2. The method of claim 1, wherein the media files further have associated content rights and further comprising:
determining, based on the information about the particular media playback device, whether the particular media playback device satisfies the content rights associated with the one or more media files; and
if the particular media playback device does not satisfy the content rights, denying transfer of the one or more media files to the particular playback device.

3. The method of claim 1, wherein the media files further have associated content rights and further comprising:
obtaining information about a user account associated with the particular media playback device, the user account having associated usage rights;
determining, based on the information about the user account, whether the usage rights satisfy the content rights associated with the one or more media files; and
if the usage rights do not satisfy the content rights, denying transfer of the one or more media files to the particular playback device.

4. The method of claim 1, wherein the information about the particular media playback device includes a unique device identifier and device capabilities for playing media files

5. The method of claim 1, further comprising:
generating a current time stamp; and
transferring the current time stamp to a secure location on the media playback device.

6. The method of claim 1, wherein the expiration rules include a maximum number of playbacks for the one or more media files.

7. The method of claim 1, wherein the expiration rules include a relative expiration time for the one or more media files.

8. The method of claim 1, wherein the expiration rules include an absolute expiration time for the one or more media files.

9. A method for updating expiration rules for media files to be played on a media playback device, comprising:
receiving a request for updating expiration rules for one or more media files;
obtaining information about a particular media playback device;
obtaining current expiration rules for the one or more media files for which an update has been requested;
comparing the current expiration rules with expiration rules stored on the content server for the one or more media files to determine if the current expiration rules can be updated;
if the current expiration rules can be updated, transferring new expiration rules from a content server to the particular media playback device;
if the current expiration rules cannot be updated, requesting a user of the particular media playback device to perform an action before the current expiration rules can be updated; and
if the user performs the requested action, transferring new expiration rules from the content server to the particular media playback device.

10. The method of claim 9, wherein the information about the particular media playback device includes a unique device identifier and device capabilities for playing media files.

11. The method of claim 9, wherein transferring new expiration rules from the content server comprises:
transferring the new expiration to a communication module that is operable to communicate with the playback device; and
transferring the new expiration rules from the communication module to the playback device.

12. The method of claim 9, wherein the current expiration rules include a maximum number of playbacks for the one or more media files.

13. The method of claim 9, wherein the current expiration rules include a relative expiration time for the one or more media files.

14. The method of claim 9, wherein the current expiration rules include an absolute expiration time for the one or more media files.

15. The method of claim 9, wherein updating the current expiration rules comprises:
generating a current time stamp; and
transferring the current time stamp to a secure location on the media playback device.

16. A method for playing a media file on a playback device, comprising:
receiving a user request to play the media file, the media file having one or more associated expiration rules;
reading the one or more expiration rules associated with the requested media file;
determining, based on the one or more expiration rules, if the media file has expired;
if the media file has expired, refusing to play the media file until one or more new expiration rules have been obtained; and
if the media file has not expired, playing the media file to the user.

17. The method of claim 16, further comprising validating a storage medium on the particular playback device.

18. The method of claim 16, wherein determining comprises:
determining if a maximum number of playbacks for the media file has been reached.

19. The method of claim 16, wherein determining comprises:
determining if a relative expiration time for the one or more media files has passed.

20. The method of claim 16, wherein determining comprises:
determining if an absolute expiration time for the one or more media files has passed.

21. A content server for transferring media files to a playback device, comprising:
means for receiving a request of one or more media files to be transferred to a particular media playback device, the one or more media files having associated expiration rules;
means for obtaining information about the particular media playback device;
means for determining, based on the information about the particular media playback device, whether the particular media playback device has the capability to enforce the expiration rules associated with the one or more media files;
means for formatting the requested one or more media files such that they can only be rendered by the particular playback device and transferring the formatted files and the expiration rules to the particular media playback device, if the media playback device has the capability to enforce the expiration rules.

22. The content server of claim 21 wherein the media files further have associated content rights and further comprising:
means for determining, based on the information about the particular media playback device, whether the particular media playback device satisfies the content rights associated with the one or more media files; and
means for denying transfer of the one or more media files to the particular playback device if the particular media playback device does not satisfy the content rights.

23. The content server of claim 21, wherein the media files further have associated content rights and further comprising:
means for obtaining information about a user account associated with the particular media playback device, the user account having associated usage rights;
means for determining, based on the information about the user account, whether the usage rights satisfy the content rights associated with the one or more media files; and
means for denying transfer of the one or more media files to the particular playback device if the usage rights do not satisfy the content rights.

24. The content server of claim 21, wherein the information about the particular media playback device includes a unique device identifier and device capabilities for playing media files

25. The content server of claim 21, further comprising:
generating a current time stamp; and
transferring the current time stamp to a secure location on the media playback device.

26. The content server of claim 21, wherein the expiration rules include a maximum number of playbacks for the one or more media files.

27. The content server of claim 21, wherein the expiration rules include a relative expiration time for the one or more media files.

28. The content server of claim 21, wherein the expiration rules include an absolute expiration time for the one or more media files.

29. The content server of claim 21, further comprising:
means for receiving a request for updating expiration rules for one or more media files;
means for obtaining information about a particular media playback device;
means for obtaining current expiration rules for the one or more media files for which an update has been requested;
means for comparing the current expiration rules with expiration rules stored on the content server for the one or more media files to determine if the current expiration rules can be updated;
means for transferring new expiration rules from a content server to the particular media playback device if the current expiration rules can be updated;
means for requesting a user of the particular media playback device to perform an action before the current expiration rules can be updated if the current expiration rules cannot be updated; and
means for transferring new expiration rules from the content server to the particular media playback device if the user performs the requested action.

30. A playback device for playing media files, comprising:
means for receiving a user request to play the media file, the media file having one or more associated expiration rules;
means for reading the one or more expiration rules associated with the requested media file;
means for determining, based on the one or more expiration rules, if the media file has expired;
means for refusing playback of the media file until one or more new expiration rules have been obtained if the media file has expired; and
means for playing the media file to the user if the media file has not expired.

31. The playback device of claim 30, further comprising means for validating a storage medium on the particular playback device.

32. The playback device of claim 30, wherein the means for determining comprises:
means for determining if a maximum number of playbacks for the media file has been reached.

33. The playback device of claim 30, wherein the means for determining comprises:
means for determining if a relative expiration time for the one or more media files has passed.

34. The playback device of claim 30, wherein the means for determining comprises:
means for determining if an absolute expiration time for the one or more media files has passed.
